(19) United States
(12) Patent Application Publication
(10) Pub. No.: US 2004/0158820 A1
(43) Pub. Date: Aug. 12, 2004

(54) System for generating an application framework and components

(76) Inventors: John Wesley Moore, Madison, WI (US); Amit Sachde, Mount Laurel, NJ (US); Mark Brian Johnson, Middleton, WI (US)

Correspondence Address: STAAS & HALSEY LLP, SUITE 700, 1201 NEW YORK AVENUE, N.W., WASHINGTON, DC, 20005, US

(21) Appl. No.: 10/361,602

(22) Filed: Feb. 11, 2003

(51) Int. Cl. G06F 9/45; G06F 9/44

(52) U.S. Cl. 717/136; 717/101

(57) ABSTRACT

The present invention is a system or tool that migrates a legacy application that has data access elements, user interface elements, and control logic. The system parses source code of a legacy application to identify data access components of the application, where the data access components comprise queries, tables, and columns. The system further parses the source code of the legacy application to identify user interface components of the application, where the user interface components comprise buttons, text boxes, and layout information describing their appearance and layout in the legacy application. The system forms an abstract representation of the data access and user interface components, and creates a new application shell having data access components and user interface components based on their abstract representation, where the new application shell is in a language different than the legacy application. The new application shell may then be manually augmented with control logic corresponding to control logic of the legacy application.

### REFERENCE TO COMPUTER PROGRAM LISTING, COMPACT DISC APPENDIX

Two compact discs (copy 1, and copy 2) are included herewith and incorporated by reference herein having thereon a computer program listing in the ASCII uncompressed text format with ASCII carriage return, ASCII line feed and all control codes defined in ASCII, having computer compatibility with IBM PC/XT/AT or compatibles, having operating system compatibility with MS-Windows, created on Feb. 11, 2003, the files are listed at the end of this specification in an Appendix.

### BACKGROUND OF THE INVENTION

1. Field of the Invention

The present invention is directed to a system for code generation. The system may be used as a migration tool to assist in migrating legacy software to a new architecture. For example, an existing PowerBuilder window can be used as a basis to automatically generate a Web based application framework.

2. Description of the Related Art

There have been two general methods of migrating software from one architecture or language to another. FIG. 1 shows a first method of migration. Starting 100 with a source application, a migration developer will manually 102 analyze the source application, and hand code 104 an analogous version of the application in the target architecture or language. This approach is slow, costly, and prone to errors. For example, a 200-window application might have 10,000 fields. In a multi-tier or Web based architecture, many of those fields or corresponding identifiers have to be duplicated repeatedly. This method is even more difficult when the original application source code may itself be difficult to read or understand. For example, PowerBuilder can export an application for migration; however, the source code exported by PowerBuilder may be convoluted, unstructured, and generally uncommented. In sum, manual migration is inefficient and unreliable.

FIG. 2 shows another method of migration. Again starting 120 with a source application, an automatic translator translates 122 the entire application by mapping low-level original source code statements to low-level target code statements, or by complex syntactic and grammatical analysis. This method also has problems when used to migrate an application such as a legacy application. Usually, applications are migrated from one high-level language to another. Automatic translation between high-level programming languages produces code that is difficult for humans to comprehend, and is usually difficult or impossible to maintain over extended use.

What is needed is a tool and technique for efficiently migrating legacy applications yet without the problems mentioned above.

### SUMMARY OF THE INVENTION

It is an aspect of the present invention to provide a tool that can automatically generate an application shell or framework with data access components and user interface components that correspond to components in an application that is being converted or migrated.

It is another aspect of the present invention to parse the source code of an original application, and to recognize and create an abstract representation of the data access and user interface elements in the original application.

It is still another aspect of the present invention to use an abstract representation of the data access and user interface elements to generate an application shell.

It is a further aspect of the present invention to provide a migration tool that automatically translates user interface and data access features of an original application by ignoring the business logic, program flow, or rules embodied in the original business application.

It is yet another aspect of the present invention to provide a two stage automatic migration process that first builds an abstract representation of a select subset of components of an original application and then uses that abstract representation to generate an application shell.

It is another aspect of the present invention to use XML as an abstract representation.

It is still another aspect of the present invention to provide a two-stage automatic migration process tool, where different original languages can be migrated or converted to a given target language without having to modify the second stage (code generation) of the migration tool, and where a given original application can be migrated to different target languages without having to modify the first stage (parsing and intermediate representation) of the migration tool.

It is a further aspect of the present invention to provide an embodiment capable of migrating PowerBuilder applications to a J2EE/Struts environment.

The above aspects can be attained by a system that identifies user interface and database access components of an original application in an original language by parsing the source code of the original application. The system generates an abstract intermediate representation of the components and uses the abstract intermediate representation to generate an application shell in a target language, where the shell is precoded with database access components and user interface components that correspond to the database access components and user interface components of the original application. In one aspect, the system can omit control logic of the original application from the abstract representation, and therefore from the target application shell.

The above aspects can also be attained by a system or tool that migrates a legacy application that has data access elements, user interface elements, and control logic. The system parses source code of a legacy application to identify data access components of the application, where the data access components comprise queries, tables, and columns. The system further parses the source code of the legacy application to identify user interface components of the application, where the user interface components comprise buttons, text boxes, dialog boxes, and layout information describing their appearance and layout in the legacy application. The system forms an abstract representation of the data access and user interface components, and creates a new application shell having data access components and user interface components based on their abstract representation, where the new application shell is in a language different than the legacy application. The new application shell may then be manually augmented with control logic corresponding to control logic of the legacy application.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a first method of migration.

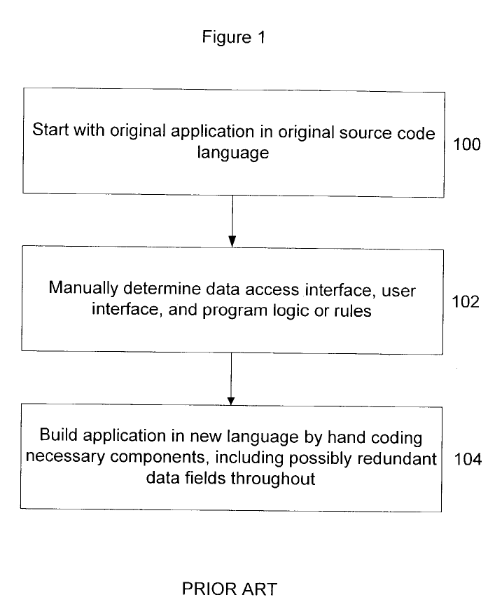

FIG. 2 shows another method of migration.

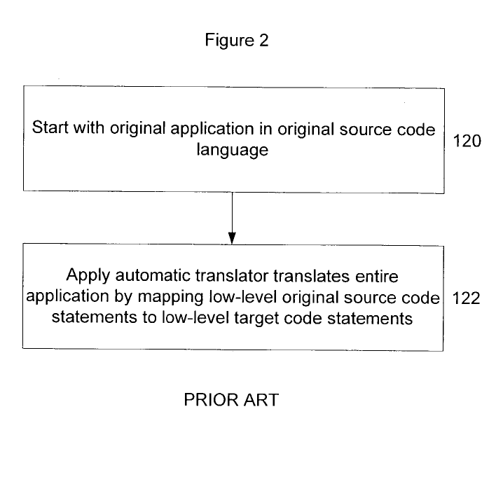

FIG. 3 shows a high-level three-stage conversion process.

FIG. 4 shows a more detailed aspect of the automatic code generation process.

FIG. 5 shows an arrangement for an embodiment for converting a PowerBuilder application to a java embodiment, or more particularly, a Java2 Enterprise Edition Struts (J2EE/Struts) embodiment.

FIG. 6 shows a general overview of a Struts based framework architecture 194.

FIG. 7 shows application java components 196 for a Struts based framework 194.

FIG. 8 shows a process of the arrangement shown in FIG. 5.

FIG. 9 shows a process of the parser 172.

FIG. 10 shows further details of parsing 220 and generating 224 an intermediate file.

FIG. 11 shows further detail of UI component parsing and UI-XML generation.

FIG. 12 shows a legacy PowerBuilder data window 240 that might appear in a typical PowerBuilder application, and the resultant Java Web page after the migration process

FIG. 13 shows a description of how source code filed with the present patent may be used to implement an aspect of the present invention.

FIG. 14 shows hardware of the present invention.

### DETAILED DESCRIPTION OF THE PREFERRED EMBODIMENTS

Introduction

Wholesale automatic translation between high level programming languages or source code (e.g. translating from Java to C) generally results in cryptic, unmanageable code, yet is fast and accurate. Manual translation between high level programming languages is inefficient and error prone, particularly when translating large-scale business applications, yet results in maintainable code that can be readily understood by a programmer. The present invention adapts a unique hybrid of these approaches with the benefits of automatic translation (speed and accuracy) and the benefits of manual migration (source code that can be cost efficiently maintained or modified by a programmer).

The inventors have recognized that many database applications have constructs or components that can be easily parsed and will usually have rough analogs in a language to which a database application might be converted. These components include data access (DA) components and user interface (UI) components. Examples might include query statements and UI widgets such as text editing fields. Furthermore, although these constructs or components may represent only a small portion of the lexicon of a database application's language, they often make up, in their instances, a substantial portion of the source code of a database application. Additionally, a migrated database application, when migrated to a new architecture such as a three-tier architecture or a web-based architecture (e.g. J2EE/Struts), may require throughout the architecture repeated references to the same database components (e.g. tables, columns, etc.). These references benefit from automatic translation or code generation.

The inventors have also recognized that the program flow logic (or control logic) that typically implements the business rules (or “brains”) of a database application is least suited for automatic translation. Using PowerBuilder as an example, the scripts in an exported PowerBuilder application would not be suitable for automatic code generation.

By first automatically translating or converting the DA and UI components of a database application, and then manually migrating the application's control logic, it is possibly to rapidly and accurately migrate the application to a new language or architecture.

General Process

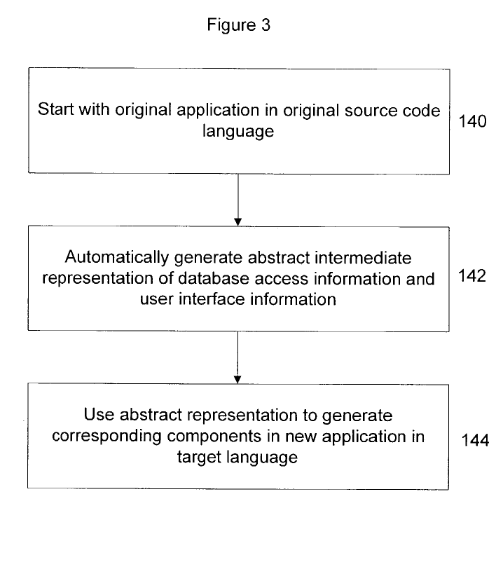

FIG. 3 shows a high-level three-stage conversion process. Starting 140 with an original application in original source code language, an abstract intermediate representation of DA information and UI information is automatically generated 142. Then, the abstract representation is used to generate 144 corresponding components in a new application shell in target language or architecture. This may be described as application framework migration, where the DA and UI framework of the application are migrated to create a corresponding new application framework, which may then be manually completed to match the original application.

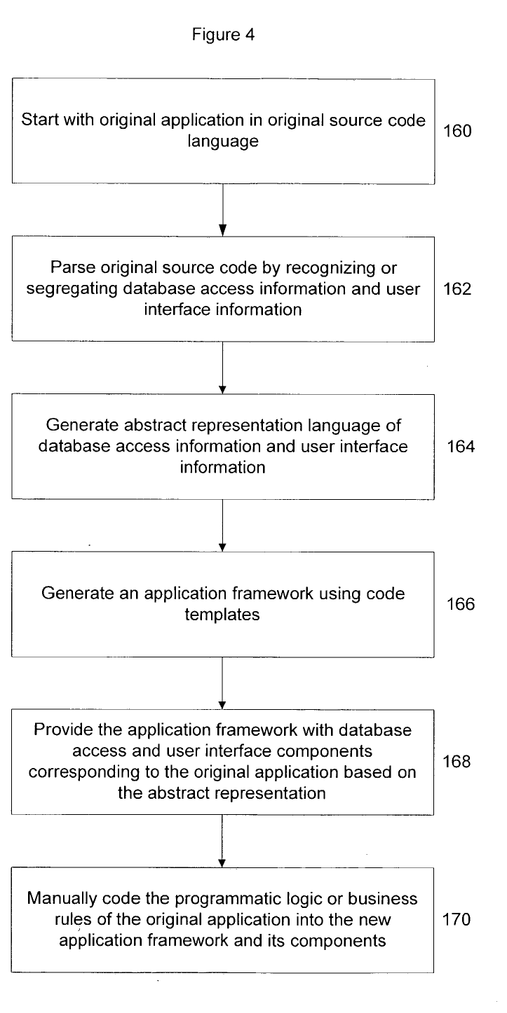

FIG. 4 shows a more detailed aspect of the automatic code generation process. Starting 160 with original application source code language, the original source code is parsed to recognize or segregate 162 DA information and UI information. The parsed out information is represented 164 in an intermediate language, for instance in XML. A new application shell or framework is generated 166, and the intermediate representation of the UI and DA information is used to generate 168 UI and DA components in the new application framework or language. The application framework may then be completed by coding 170 it with the programmatic logic or business rules of the original application.

The application shell or framework mentioned above may be built with proprietary code and libraries, may be based on a standard, such as J2EE/Struts. In a preferred embodiment, a combination thereof is used. A Struts implementation is preferably customized into a foundation or framework. Preferably, the application framework will incorporate coding standards, standard libraries, and other elements common among applications in the target language or architecture. Shell objects may be formed using object coding standards. The application framework may be built using code templates, discussed later. And the legacy component, as represented in the intermediate format, is applied with the templates to the XML files, to create code that will work with the new framework.

Powerbuilder to J2EE/Struts Embodiment

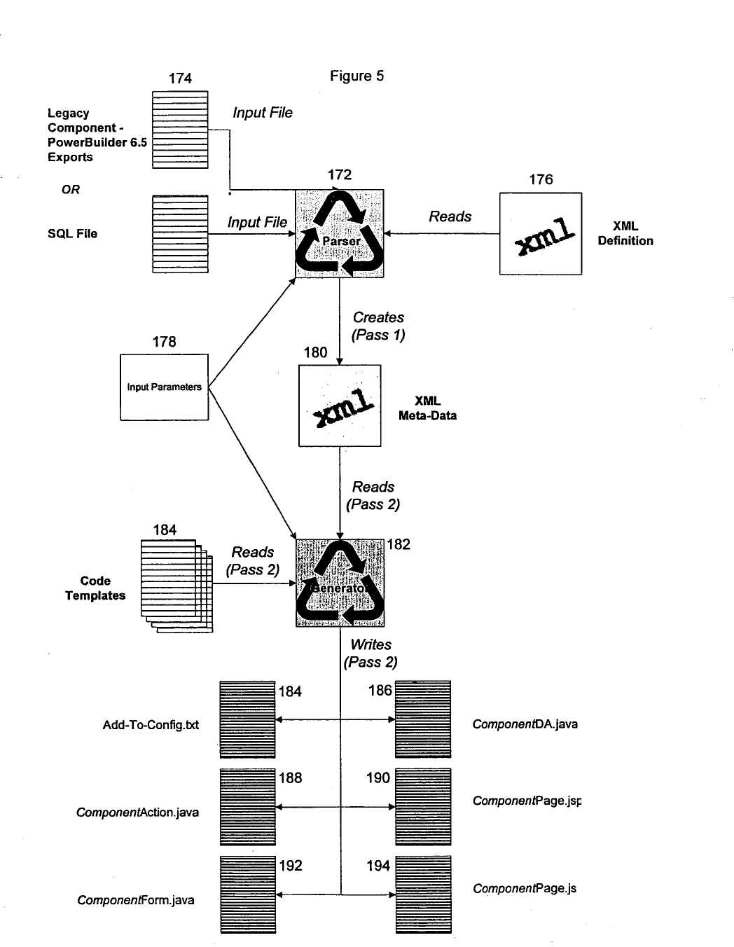

FIG. 5 shows an arrangement for an embodiment for converting a PowerBuilder application to a java embodiment, or more particularly, a Java2 Enterprise Edition Struts (J2EE/Struts) embodiment. A parser 172, preferably written in java, reads input file or files 174. The parser 172 also either reads an XML data definition file 176, or includes a reference thereto. The input files 174 are generated using a PowerBuilder export tool. Input parameters 178, preferably command line parameters, may be used at runtime to choose specific objects for processing, such as a PowerBuilder datawindow, a tab, a whole window, an SQL statement, etc. The parser 172 outputs XML meta-data 180, which is the intermediate representation of the PowerBuilder components being automatically migrated. A code generator 182 receives the XML meta-data 180 and code framework templates 184. The code generator 182 outputs various java, javascript, jsp, and configuration files 184, 186, 188, 190, 192, 194 necessary for a J2EE/Struts application.

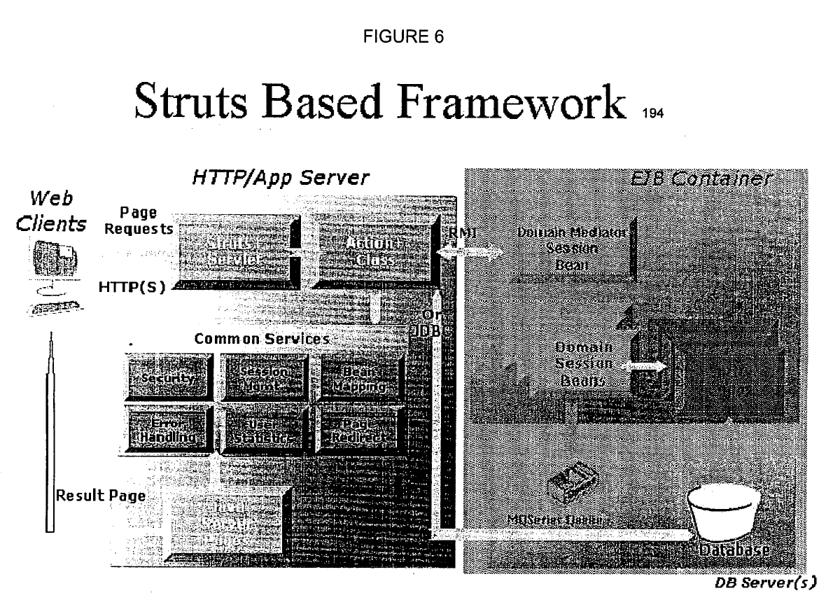

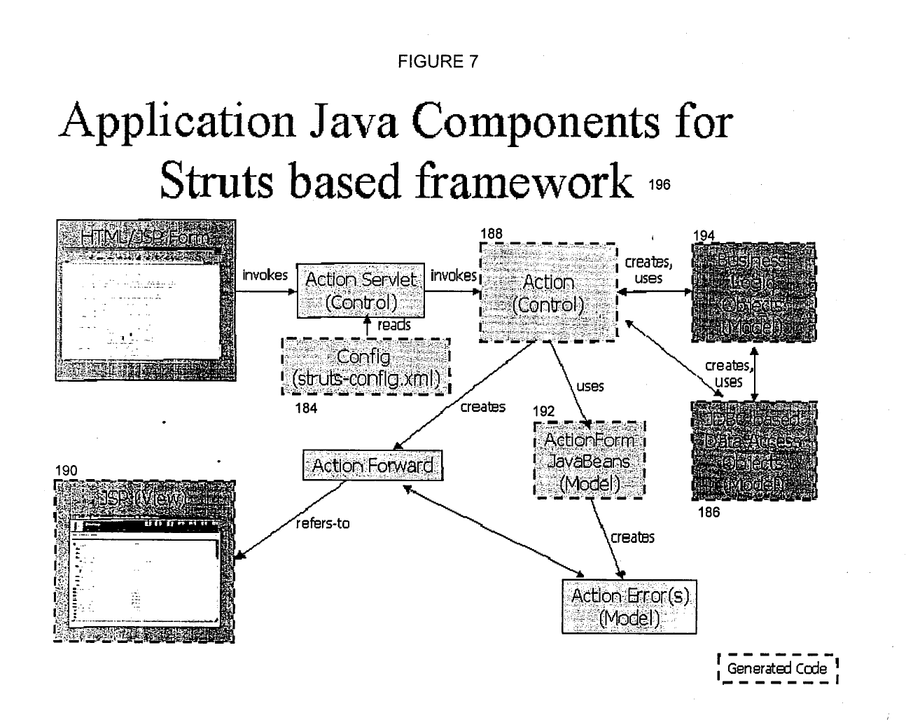

FIG. 6 shows a general overview of a Struts based framework architecture 194. The framework shown in FIG. 6 is an implementation of Struts that includes added support for common services, such as security, error handling, etc. FIG. 7 shows application java components 196 for a Struts based framework 194. Various java components 184, 186, 188, 190, 192, 194 correspond to files generated by the code generator 182, as shown in FIG. 5. FIG. 7 is a typical Struts diagram, and illustrates typically generated Struts components.

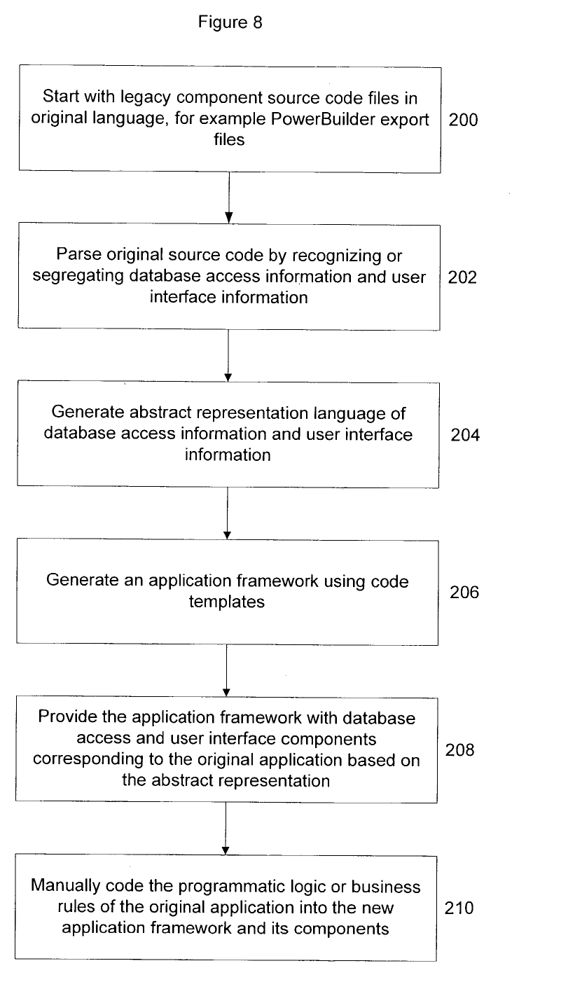

FIG. 8 shows a process of the arrangement shown in FIG. 5. The process starts 200 with legacy component source code files in an original language, for example PowerBuilder export files 174. The original source code 174 is parsed by the parser 172 according to the input parameters 178, and the parser 172 recognizes or segregates 202 database access information and user interface information in the original application. The parser 172 then generates 204 an abstract representation of the database access information and user interface information, which is output as the XML meta-data file 180. The XML meta-data file 180 is generated to conform to the structure or layout in the XML definition or data type definition (DTD) file 176. Although in one embodiment the parser 172 can be hard-coded with logic to produce XML output compliant with the DTD of the XML definition file 176, the XML definition file 176 could also be used by the parser 172 as a grammar for producing code compliant with the type defined by the DTD file. Generally, one DTD is provided for abstract UI components and another DTD is provided for abstract DA components. The DTD reference in the document header allows validating parsers to check the syntax of the XML document, including the data. This guarantees a valid input XML document for the generator.

After the generation 204 of the XML meta-data file 180, the code generator 182 generates 206 an application framework using code templates 184. The code generator 182 then applies the XML meta-data file 180 to provide 208 the application framework with database access and user interface components corresponding to the original application based on their abstract representations in the XML meta-data file 180. Some additional output code, which can be created by a person of ordinary skill in the art, may be needed to help the form class 192 understand what the dataaccess class 186 is doing, however, only data manipulation language (insert, update, select, etc.) is generally created. No data definition language (e.g. schema) need be produced or converted when a same database is being used by the source and target applications.

Finally, manually coding 208 may be performed to add the programmatic logic or business rules of the original application into the new application framework and its components.

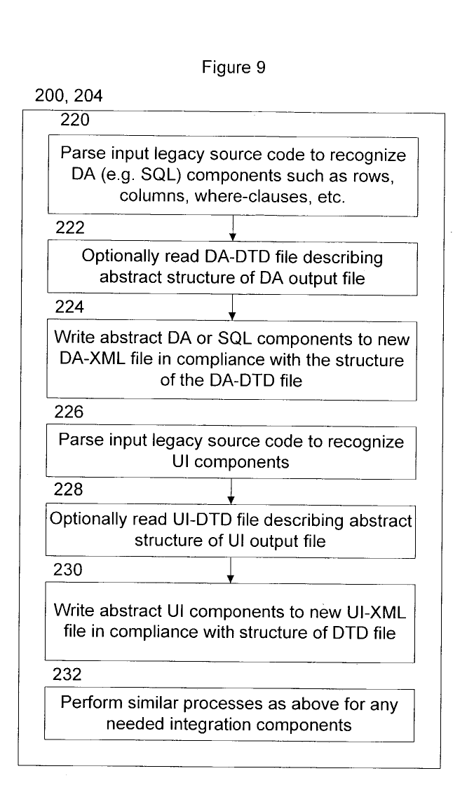

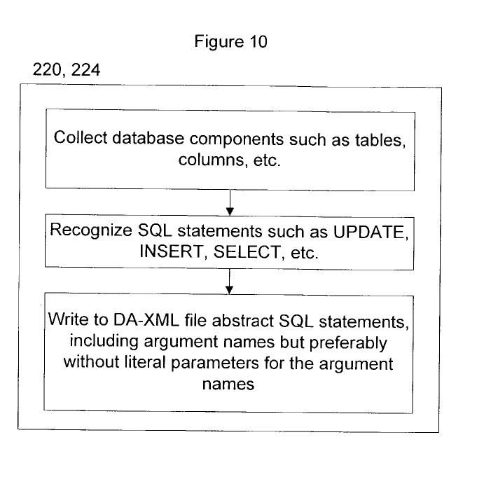

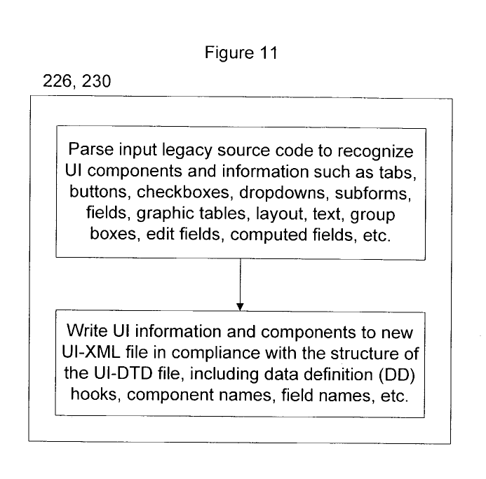

FIG. 9 shows a process of the parser 172. The parser 172 parses legacy source code to recognize 220 DA (e.g. SQL) components, such as rows, columns, where-clauses, tables, etc. Optionally a DA-DTD file (an XML meta-data file 190) describing an abstract structure of DA output XML file is read 222, and abstract DA components are written 224 to a new DA-XML file in compliance with the structure of the DA-DTD file. Similar steps 226, 228, 230 are performed for user interface components. Any other extraneous components, such as integration components are included 232. FIG. 10 shows further details of parsing 220 and generating 224 an intermediate file. FIG. 11 shows further detail of UI component parsing and UI-XML generation.

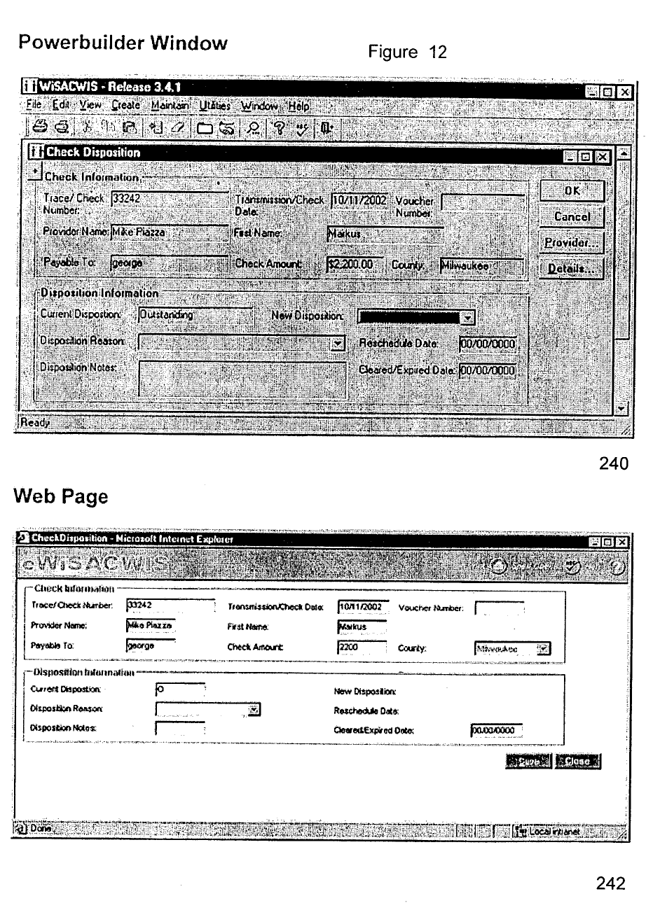

FIG. 12 shows a legacy PowerBuilder data window 240 that might appear in a typical PowerBuilder application. Web page 242 is an analogous form/window of the application shell or framework produced by the processes and arrangements discussed above. The web page 242 is a graphical database access window of a new application. The web page 242 has graphical elements for viewing or editing fields in a database (e.g. “Payable To”, and an entry field). The web page 242 has a displayed appearance corresponding to an appearance of the form or window 240 of a legacy application, and the web page 242 uses an underlying database interface corresponding to a database interface used by the form or window 240 of the legacy application. The graphical elements of the new application web page 242 correspond to the graphical elements of the legacy application. The component correspondence and layout correspondence is a natural result of the automatic migration or conversion described above—no coding is required. An accompanying compact disc (CD) includes a concrete implementation of a code generator (“pb65*jspWriter.java”). This example of a code generator adheres to the XML DTD specifications as defined by XML meta-data 180. Any other legacy system can have a similar code generator, which can understand its specific implementations that need to be converted.

A benefit of the two-stage migration discussed above is that a different or new original application language or system may be accommodated by developing a new parser, code templates, DTD files, etc. that is specific to the new or different original application language and used for generating the intermediate abstract representation (e.g. XML meta-data). The same code generator and related resources may then be re-used to convert the abstract representation to the same target language or architecture. Similarly, a different or new target architecture or language may be accommodated by developing a new code generator and related resources; the front-end generation of the intermediate representation specific to the same original application language may be re-used.

Furthermore, the present invention can be used as a more general code generation tool. For example, a new application could be abstractly and directly described by a programmer in XML or another definition language, and then a framework could be generated and programming with the framework would begin with the groundwork laid; UI and DA components would be in place, and only control logic would need to be programmed.

Example of a Migration

An example of a legacy PowerBuilder to J2EE/Struts migration is discussed below. The parser is invoked with parameters to indicate a desire to generate a J2EE component for a window called “case registration”. A window (form) with multiple database components can have multiple pages or screens, each with different information and potentially accessing multiple different tables. In the case of a PowerBuilder window, the window must be checked for UI tabs, which are named in an exported definition file. The parser looks at the input files (e.g. legacy components) to figure out how many tabs, if any, the window has (whether has tabs or not, the parsing algorithm is basically the same, it just branches within itself). The parser also determines all the DA components are for the particular form.

In the “case registration” example, the legacy source files are read to figure out how many or what database components “case registration” needs access to, for example case, registration, person, and address tables required by the “case registration” form. For every such needed database component or resource, the parser applies XML data in three separate XML files: a DA XML file, a jsp XML file, and a form XML file. The DA XML file has all the data manipulation language (DML), and describes necessary tables, fields, retrieval criteria, datatypes of the fields, etc. The jsp XML file has the UI information.

If there is a one-to-many relation between database components, for example between person and case tables, that relation will be reflected in the XML files. Repeating relations (one-to-many) are possible, and the parser will create multiple form objects, and will create the one-to-many relation in the form object, so when the form object is read, it is informed that the main form and its subforms repeat therein. For example, if one form is for person information, and another form is generated for the address, inside the person form will be information indicating the one-to-many relation between the forms; multiple form objects are created.

The code is generated by reading the DA XML file, the form XML file, and the jsp XML file, and a set of procedures are created for reading the data, updating the data, inserting data, etc. Other components relevant to the handshake from the form to the DA class (the ComponentAction file, discussed later) are also included. A config file for required for J2EE components is created. It tells what the components of the form are: in the web environment analog to a page, a page is like a topic, and has many components, one is the page itself, one is an action class, one is a form class, one is an action.

Finally, the writer or generator reads the JSP XML file (the UI XML file) to create a page that represents the data elements from the DA class onto a web page. It may have fields like name, address, tabs, put buttons on the page (save, close, etc.), and otherwise group the information together. The writer or generator is complete at this point. Further steps may be necessary to put the generated code to use. For example, the generated pieces of code may be put into a development environment and compiled, and the base pages will then be ready for be manually programmed for control or program logic.

Description of Included Source Code

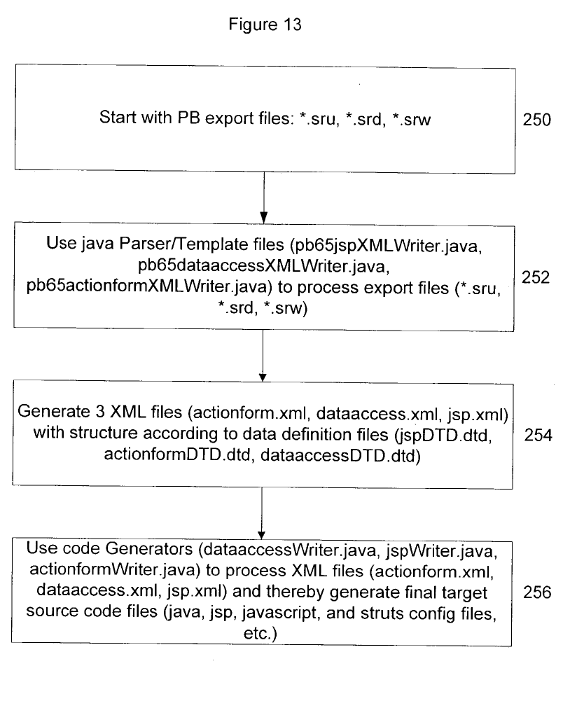

FIG. 13 shows a description of how source code filed with the present patent may be used to implement an aspect of the present invention. Starting 250 with files exported by PowerBuilder, the parser, comprised of three PowerBuilder-specific java “XMLWriter” files parse 252 the exported PowerBuilder files, and each generates 254 a corresponding intermediate XML file. Three generic java programs (componentwriter.java), which are not-specific to PowerBuilder or any other system, the use 256 the intermediate XML files to write out various java, javascript, jsp, and other files for a J2EE/Struts framework.

Typical Hardware

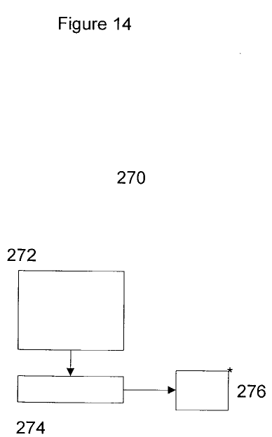

FIG. 14 shows hardware of the present invention. The present invention may include a system 270, such as depicted in FIG. 14, which includes a display 272 upon which an output of the present invention may be displayed. A computer or CPU 274, preferably of the high performance workstation type, performs the processes described herein and an input device 276, such as a mouse or stylus with pad, is used to control functionality described herein. The system 270 also includes storage (not shown), such as disc storage and RAM in which the processes of the present invention can be stored and on which the processes can be distributed. The processes can also be distributed via a network, such as the Internet. The present invention may also be distributed over a number of cooperating systems 270.

Conclusion

The present invention has been described with respect to a system that identifies user interface and database access components of an original application in an original language by parsing the source code of the original application. The system generates an abstract intermediate representation of the components and uses the abstract intermediate representation to generate an application shell in a target language, where the shell has database access components and user interface components that correspond to the database access components and user interface components of the original application. In one aspect, the system can omit control logic of the original application from the abstract representation, and therefore from the target application shell.

In another aspect, the present invention can also be used for projects where there is no migration effort. The generator can be used to generate application shells purely based on the XML definitions of the data that is to be presented on the user interface or based on data elements from the database. This will accelerate application development and goes beyond standard object model based code generation since it covers the entire spectrum of components in a web-application. The time saved helps reduce project costs and enforces standards and architecture pattern compliance.

The many features and advantages of the invention are apparent from the detailed specification and, thus, it is intended by the appended claims to cover all such features and advantages of the invention that fall Within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

APPENDIX
Listing of files on Compact Disc Incorporated Herein,
with a root directory of “D:”.

Directory of D:\
<DIR> codegenerator

1,340 d_code_fm03_agency.srd
1,410 d_code_fm03_cancel_rsn.srd
1,488 d_code_fm03_cd_t18.srd
1,403 d_code_fm03_iv_e.srd
1,385 d_code_fm03_med_stat.srd
1,389 d_code_fm03_state.srd
1,190 d_fm03_address_change.srd
5,603 d_fm03_cert_header.srd
34,132 d_fm03_certification.srd
62,210 d_fm03_datastore.srd
2,504 d_fm03_ds_town.srd
2,840 d_fm03_ds_zip.srd
14,463 d_fm03_elig_medicaid.srd
7,131 d_fm03_fast_unit_status.srd
16,884 d_fm03_med_cert_hstry.srd
33,944 d_fm03_med_certification.srd
13,641 d_fm03_medicaid_address.srd
4,807 d_fm03_medicaid_temp.srd
4,632 d_fm03_mmis_status.srd
7,249 d_fm03_stat_approval.srd
1,769 fm03_MedicaidCertification.js
11,436 fm03_MedicaidCertification.jsp
539 FM03_MedicaidCertification.struts-config.txt
7,050 FM03_MedicaidCertificationAction.java
1,673 FM03_MedicaidCertificationBL.java
68,857 FM03_MedicaidCertificationDA.java
25,621 FM03_MedicaidCertificationForm.java
1,769 fm03_MedicaidEligibilityDetermination.js
7,839 fm03_MedicaidEligibilityDetermination.jsp
638 FM03_MedicaidEligibilityDetermination.struts-config.txt
7,413 FM03_MedicaidEligibilityDeterminationAction.java
1,761 FM03_MedicaidEligibilityDeterminationBL.java
20,216 FM03_MedicaidEligibilityDeterminationDA.java
8,808 FM03_MedicaidEligibilityDeterminationForm.java
13,822 FM03_MedicaidEligibilityDeterminationMedCertHstry.java
306 udw_fm03_address_change.sru
1,296 udw_fm03_cert_header.sru
1,410 udw_fm03_certification.sru
2,132 udw_fm03_elig_medicaid.sru
1,399 udw_fm03_fast.sru
2,206 udw_fm03_med_cert_hstry.sru
14,099 udw_fm03_medicaid_address.sru
16,615 udw_fm03_medicaid_temp.sru
1,386 udw_fm03_mmis.sru
1,385 udw_fm03_state.sru
19,544 w_fm03_elig_medicaid.srw
137,574 w_fm03_med_certification.srw
6,021 w_fm03_medicaid_temp.srw

Directory of D:\codegenerator
<DIR> core
<DIR> pb
<DIR> pb65
<DIR> pb8
<DIR> referencedata
<DIR> sql

46,902 pb65toJ2EE.java

Directory of D:\codegenerator\core
<DIR> actionformXML
<DIR> componentXML
<DIR> dataaccessXML
<DIR> jspXML
Directory of D:\codegenerator\core\actionformXML

2,436 ACTIONFORM.java
443 actionformDTD.dtd
4,966 ACTIONFORMFactory.java
34,422 ActionFormWriter.java
1,241 actionformXMLReader.java
678 COMPONENTNAME.java
1,089 FORM.java
651 NAME.java
651 PATH.java
663 STARTTAB.java
1,342 SUBFORM.java
654 TOPIC.java
1,278 VARIABLE.java
675 VARIABLENAME.java
675 VARIABLETYPE.java

Directory of D:\codegenerator\core\componentXML

16,816 ActionWriter.java
7,049 BLWriter.java
1,811 COMPONENT.java
286 componentDTD.dtd
3,255 COMPONENTFactory.java
311 COMPONENTNAME.java
1,232 componentXMLReader.java
6,504 JSWriter.java
284 NAME.java
284 PATH.java
296 STARTTAB.java
6,470 StrutsConfigEntryWriter.java
536 SUBFORM.java
287 TOPIC.java

Directory of D:\codegenerator\core\dataaccessXML

4,344 ActionFormTemplate.xml
1,278 ARGUMENT.java
675 ARGUMENTNAME.java
675 ARGUMENTTYPE.java
657 COLUMN.java
669 COLUMNNAME.java
675 COLUMNNUMBER.java
1,560 COLUMNPREP.java
669 COLUMNTYPE.java
678 COMPONENTNAME.java
3,669 DATAACCESS.java
1,453 dataaccessDTD.dtd
11,803 DATAACCESSFactory.java
47,020 DataAccessWriter.java
1,244 dataaccessXMLReader.java
669 DATAWINDOW.java
1,089 FORM.java
3,087 INSERT.java
651 JOIN.java
651 NAME.java
651 PATH.java
1,193 PBCOMMENT.java
4,281 SELECT.java
663 SQLCOUNT.java
663 STARTTAB.java
1,342 SUBFORM.java
672 SUBFORMNAME.java
648 TAB.java
654 TABLE.java
654 TOPIC.java
4,662 UPDATE.java
672 UPDATETABLE.java
654 VALUE.java
1,278 VARIABLE.java
675 VARIABLENAME.java
675 VARIABLETYPE.java
654 WHERE.java

Directory of D:\codegenerator\core\jspXML

653 COLSPAN.java
2,921 COLUMN.java
671 COMPONENTNAME.java
665 DDATTRIBUTE.java
650 DDDATA.java
659 DDDISPLAY.java
662 DDFUNCTION.java
653 DDIDGRP.java
650 DDNAME.java
1,192 DIV.java
1,204 DIVLINK.java
653 DIVNAME.java
659 DIVNUMBER.java
1,507 DROPDOWN.java
661 FIELDNAME.java
659 FIELDSIZE.java
659 FIELDTYPE.java
916 HEADER.java
3,268 JSP.java
1,267 jspDTD.dtd
10,334 JSPFactory.java
57,844 JSPWriter.java
1,129 jspXMLReader.java
644 PATH.java
1,051 ROW.java
656 STARTTAB.java
1,081 SUBFORMDETAIL.java
1,081 SUBFORMHEADER.java
665 SUBFORMNAME.java
1,634 TAB.java
2,284 TABLE.java
656 TABNAME.java
662 TABNUMBER.java
644 TEXT.java
647 TOPIC.java
1,274 VARIABLE.java
671 VARIABLENAME.java
671 VARIABLETYPE.java

Directory of D:\codegenerator\pb
<DIR> Object
Directory of D:\codegenerator\pb\Object

988 jspVariableObject.java
1,195 pbDataWindowColumnTypes.java
1,571 pbDataWindowGenericColumn.java
723 pbDataWindowGroupboxColumn.java
1,683 pbDataWindowObject.java
3,540 pbDataWindowSpecialColumn.java
843 pbDataWindowTextColumn.java
1,092 pbTabObject.java
1,605 pbWindowObject.java
928 subformVariableObject.java

Directory of D:\codegenerator\pb65
<DIR> Parser
<DIR> Reader
<DIR> XMLReadWriter
Directory of D:\codegenerator\pb65\Parser

42,205 pb65DropDownDataWindowParser.java
5,779 pb65GroupboxColumnParser.java
36,268 pb65SpecialColumnParser.java
10,724 pb65TextColumnParser.java

Directory of D:\codegenerator\pb65\Reader

26,320 pb65DataWindowObjectReader.java
14,446 pb65TabObjectReader.java
3,779 pb65UDWObjectReader.java
25,396 pb65WindowObjectReader.java

Directory of D:\codegenerator\pb65\XMLReadWriter

35,410 pb65ActionFormXMLWriter.java
33,003 pb65ComponentXMLWriter.java
142,497 pb65DataAccessXMLWriter.java
292,580 pb65JSPXMLWriter.java
30,754 pbMockWindowActionFormXMLWriter.java
72,186 pbMockWindowDataAccessXMLWriter.java
292,890 pbMockWindowJSPXMLWriter.java

Directory of D:\codegenerator\pb8
<DIR> Parser
<DIR> Reader
Directory of D:\codegenerator\pb8\Parser

42,290 pb8DropDownDataWindowParser.java
5,807 pb8GroupboxColumnParser.java
36,339 pb8SpecialColumnParser.java
10,748 pb8TextColumnParser.java

Directory of D:\codegenerator\pb8\Reader

26,498 pb8DataWindowObjectReader.java
14,501 pb8TabObjectReader.java
3,819 pb8UDWObjectReader.java
25,492 pb8WindowObjectReader.java

Directory of D:\codegenerator\referencedata
<DIR> Reader

7,209 component_lookup
9,044 win_classes

Directory of D:\codegenerator\referencedata\Reader

4,088 pb65ComponentLookupFileReader.java
4,047 pb65WinClassesFileReader.java

Directory of D:\codegenerator\sql

5,376 pb65SqlExtractor.java
33,859 SQLFileReader.java
35,725 sqlParser.java

What is claimed is:

1. A method for migrating a legacy application, the legacy application comprising data access elements, user interface elements, and control logic, the method comprising:
parsing source code of the legacy application to identify data access components of the application, where the data access components comprise queries, tables, and columns;
further parsing the source code of the legacy application to identify user interface components of the application, where the user interface components comprise buttons, text boxes, and layout information describing their appearance and layout in the legacy application;
forming an abstract representation of the data access and user interface components;
using the abstract representation to create a new application shell comprising data access components and user interface components based on their corresponding abstract representation, where the new application shell is in a source code language different than the legacy application; and
manually augmenting the new application shell with control logic corresponding to the control logic of the legacy application.

2. A method for migrating a PowerBuilder application, the PowerBuilder application comprising a data window, data access elements, user interface elements, and control logic, to an object-oriented application shell with corresponding data access and user interface elements and substantially without corresponding automatically migrated control logic corresponding to control logic of the PowerBuilder application, the method comprising:
parsing the exported source code of the PowerBuilder application to identify data access components of the PowerBuilder application, where the data access components comprise queries, tables, and columns;
parsing the exported source code of the PowerBuilder application to identify user interface components of the application, where the user interface components comprise buttons, text boxes, and layout information describing their appearance and layout in the PowerBuilder application;
forming an abstract representation of the data access and user interface components;
using the abstract representation to automatically create the object-oriented application shell comprising object-oriented source code comprising data access objects and user interface objects based on the abstract representation of the data access components and user interface components, where the object-oriented application shell is substantially without automatically generated control logic corresponding to the control logic of the PowerBuilder application; and
manually augmenting the object-oriented application shell with control logic corresponding to the control logic of the legacy application.

3. A method according to claim 2, wherein the object-oriented application shell is one of a java application and a J2EE Struts application.

4. A method for automatically generating an application shell, comprising:
automatically identifying user interface and database access components of an original application in an original language by parsing the source code of the original application;
automatically generating an abstract intermediate representation of the components; and
using the abstract intermediate representation to automatically generate the application shell in a target language, where the shell has database access components and user interface components that correspond to the database access components and user interface components of the original application.

5. A method according to claim 4, wherein the identifying and generating of the application shell is done with a migration tool comprising a parsing stage and a code generation stage, where the parsing stage produces the abstract intermediate representation of the components, and where the code generation stage uses the representation to generate the application shell.

6. A method according to claim 5, wherein the parsing stage is capable of being used with a different code generation stage, specific to another target language, to generate an application shell in the other target language, and wherein the application shell in the other target language has database access and user interface components corresponding to those of the original application.

7. A method according to claim 5, wherein the same code generation stage is capable of being used with a different parsing stage, specific to another original language, to automatically generate an application shell in the same target language.

8. A method according to claim 4, wherein the identifying further comprises substantially omitting control logic of the original application, whereby the intermediate representation and application shell are substantially devoid of program control logic found in the original application.

9. A method according to claim 8, further comprising manually coding the application shell to include control logic corresponding to the control logic found in the original application, where the manually coded control logic is in the language of the application shell.

10. A method according to claim 9, wherein the original application is in PowerBuilder-exported source code and the original language corresponds to the same.

11. A method according to claim 4, wherein the original application is in PowerBuilder-exported source code and the original language corresponds to the same.

12. A method of code migration, comprising:
using a migration tool to automatically identify a subset of constructs in a legacy application, where the subset substantially excludes programmatic control logic of the legacy application;
generating, with the migration tool, a representation of the subset of constructs using an abstract grammar or data definition language; and
automatically generating an application shell with components corresponding to and based on the constructs in the representation.

13. A method according to claim 12, wherein the subset of constructs consists of data access components and user interface components.

14. A method according to claim 12, wherein the subset of constructs consists of data access components.

15. A method according to claim 12, wherein the subset of constructs consists of data user interface components.

16. A method according to claim 12, wherein the subset of constructs comprises data access components and user interface components.

17. A computer for executing software for code migration or generation, the software comprising:
a parser automatically identifying user interface and database access components of an original application in an original language by parsing the source code of the original application;
the parser automatically generating an abstract intermediate representation of the components; and
a code generator using the abstract intermediate representation to automatically generate the application shell in a target language, where the shell has database access components and user interface components that correspond to the database access components and user interface components of the original application.

18. A computer according to claim 17, further comprising an interface allowing a user to add business logic in the target language to the shell, the business logic corresponding to business logic in the original application.

19. An apparatus for code migration or generation, comprising:
a parsing means for automatically identifying user interface and database access components of an original application in an original language by parsing the source code of the original application;
intermediate representation means for automatically generating an abstract intermediate representation of the components; and
a code generator means for using the abstract intermediate representation to automatically generate the application shell in a target language, where the shell has database access components and user interface components that correspond to the database access components and user interface components of the original application.

20. A computer-readable storage storing information capable of enabling a computer to perform a process, the process comprising:
automatically identifying user interface and database access components of an original application in an original language by parsing the source code of the original application;
automatically generating an abstract intermediate representation of the components; and
using the abstract intermediate representation to automatically generate the application shell in a target language, where the shell has database access components and user interface components that correspond to the database access components and user interface components of the original application.

21. A data structure, comprising:
an abstract intermediate representation describing user interface and database access components of an original application in an original language, where the abstract intermediate representation is generated by automatically parsing source code of the original application, and where the abstract representation is capable of being used to automatically generate an application shell in a target language, where the application shell has database access components and user interface components that correspond to the database access components and user interface components of the original application.

22. A user interface comprising:
a graphical database access window of a new application, the window comprising graphical elements for viewing or editing fields in a database, where the window has a displayed appearance corresponding to an appearance of a form or window of a legacy application, where the window uses a database interface corresponding to a database interface of the form or window of the legacy application, where the graphical elements of the new application correspond to graphical elements of the legacy application, and where the graphical database access window of the new application has been automatically converted from the legacy application.

23. A user interface according to claim 22, wherein the graphical elements of the new application have a layout corresponding a layout of the graphical elements of the legacy application.
